(19) United States
(12) Patent Application Publication
(10) Pub. No.: US 2007/0266046 A1
(43) Pub. Date: Nov. 15, 2007

(54) Method of Providing Medical Content, and Medical Communication System

(75) Inventor: John Koivukangas, Oulu (FI)

Correspondence Address: YOUNG & THOMPSON, 745 SOUTH 23RD STREET, 2ND FLOOR, ARLINGTON, VA, 22202, US

(73) Assignee: Onesys OY, Oulu (FI)

(21) Appl. No.: 11/665,327

(22) PCT Filed: Oct. 12, 2005
(86) PCT No.: PCT/FI05/50356

§ 371 Date: Apr. 13, 2007

(30) Foreign Application Priority Data
Oct. 13, 2004 (FI) 20045386

(51) Int. Cl. G06F 17/00

(52) U.S. Cl. 707/104.1

(57) ABSTRACT

There is provided a method of providing medical content in a medical communication system, the method comprising retrieving medical content items stored in separate medical databases in the medical communications system, the medical content items being related to a predetermined patient. The method further comprising assembling the retrieved medical content items and any other information related to the predetermined patient on at least one medical workspace; relating the medical content items on the at least one medical workspace to a particular moment in time; and storing the medical workspace including the medical content items related to the particular moment in time for examining at a later time.

### FIELD

The invention relates to a method of providing medical content in a medical communication system, to a medical communication system, to a terminal device for a medical communication system, and to a computer program product encoding a computer program of instructions for executing a computer process for providing medical content in a medical communication system.

### BACKGROUND

Presently, most of the information collected and stored during the course of patent care is being digitized all over the world. There are, for example, electronic patient record (EPR) systems for text-based patient information, laboratory information systems and radiological picture archiving and communications systems (PACS).

While the information in these systems can be accessed and reviewed over digital networks using personal computers or workstations all over the territory of a health care service provider, for example a hospital, the information databases are separately stored and need to be separately accessed. Thus, when a user, for example a doctor or health care personnel, needs to review the information in separate databases, the databases need to be accessed and reviewed separately. New text can be entered into the EPR; these momentary notes forming a part of the EPR just as they did when paper versions were being used. PACS information remains in the field of radiological archiving systems, and when PACS information is needed, it has to be accessed separately again. In essence, the digital system is an electronic form of the old paper- and film-based one and EPR information is reviewed a page at a time, while PACS information is reviewed, for example, as whole presentations of imaging sessions.

While information in the EPR serves to record and date various results of information analysis and any decisions made, all of the separate information systems need to accessed each time one wishes to review what has taken place in the past and why. This results in unnecessary time costs, impaired quality control and inefficient productivity.

### BRIEF DESCRIPTION OF THE INVENTION

An object of the invention is to provide an improved method of providing medical content, an improved medical communication system, an improved terminal device, and an improved computer program product.

According to an aspect of the invention, there is provided a method of providing medical content in a medical communication system, the method comprising retrieving medical content items stored in separate medical databases in the medical communications system, the medical content items being related to a predetermined patient. The method further comprising: assembling the retrieved medical content items and any other information related to the predetermined patient on at least one medical workspace; relating the medical content items on the medical workspace to a particular moment in time; and storing the medical workspace including the medical content items related to the particular moment in time for examining at a later time.

According to another aspect of the invention, there is provided a medical communication system, comprising: a terminal device and several medical database storing systems communicating with the terminal device over a communications connection, the terminal device being configured to retrieve medical content items stored in medical databases of the several medical database storing systems, the medical content items being related to a predetermined patient. The terminal device is further configured to assemble the retrieved medical content items and any other information related to the predetermined patient on at least one medical workspace; to relate the medical content items on the at least one medical workspace to a particular moment in time; and to store the medical workspace including the medical content items related to the particular moment in time for examining at a later time.

According to another aspect of the invention, there is provided a terminal device for a medical communication system, the terminal device comprising a processing unit for controlling functions of the terminal device, a communications unit for communicating with medical database storing systems, a memory, and a user interface, the communications unit being configured to retrieve medical content items stored in medical databases of the medical database storing systems, the medical content items being related to a predetermined patient. The processing unit is configured to assemble the retrieved medical content items and any other information related to the predetermined patient on at least one medical workspace; to relate the medical content items on the at least one medical workspace to a particular moment in time; and to store the medical workspace including the medical content items related to the particular moment in time in the memory for examining at a later time.

According to another aspect of the invention, there is provided a computer program product encoding a computer program of instructions for executing a computer process for providing medical content in a medical communication system, the process comprising: retrieving medical content items stored in separate medical databases in a communications system, the medical content items being related to a predetermined patient; assembling the retrieved medical content items and any other information related to the predetermined patient on at least one medical workspace; relating the medical content items on the at least one medical workspace to a particular moment in time; and storing the medical workspace including the medical content items related to the particular moment in time for examining at a later time.

According to another aspect of the invention, there is provided a terminal device for a medical communication system, the terminal device comprising a processing unit for controlling functions of the terminal device, a communications unit for communicating with medical database storing systems, a memory, and a user interface, the communications unit retrieves medical content items stored in medical databases of the medical database storing systems, the medical content items being related to a predetermined patient. The processing unit further comprises: assembling means for assembling the retrieved medical content items and any other information related to the predetermined patient on at least one medical workspace; relating means for relating the medical content items on the at least one medical workspace to a particular moment in time; and storing means for storing the medical workspace including the medical content items related to the particular moment in time in the memory for examining at a later time.

The invention provides several advantages. Massive amounts of information do not have to reviewed each time decisions concerning a particular patient is being made. Thus, the frustration of having to go through an amount of old records and different data bases is reduced considerably. Various kind of medical information are summarized in one easily accessible place. Costs are minimized, quality of patient care is improved and productivity is increased.

### LIST OF DRAWINGS

In the following, the invention will be described in greater detail with reference to the embodiments and the accompanying drawings, in which

FIG. 1 shows an example of a medical communications system;

FIG. 2 illustrates an example of a terminal device, and

FIG. 3 illustrates a method of providing medical content in a medical communication system.

### DESCRIPTION OF EMBODIMENTS

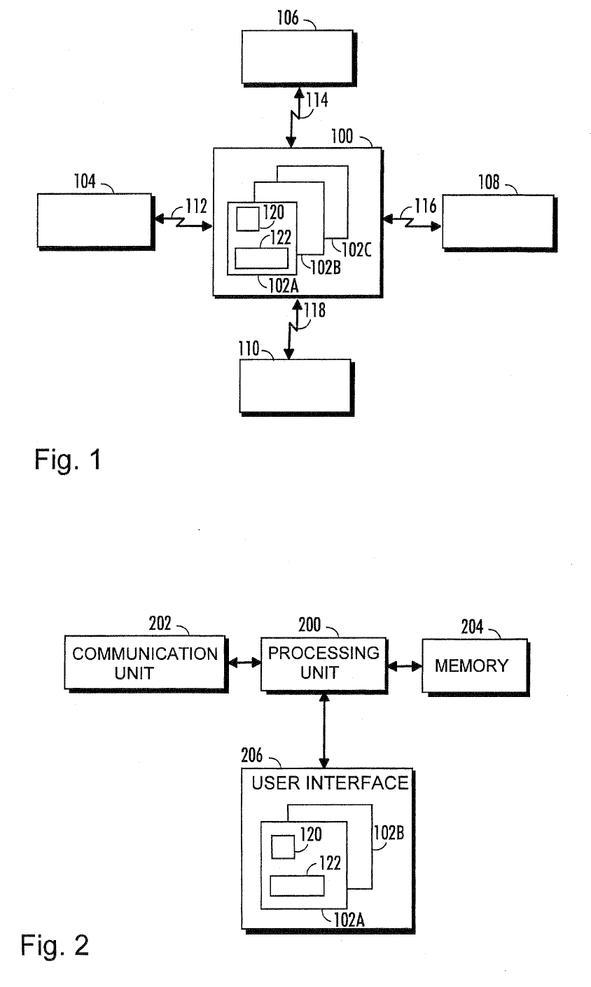

With reference to FIG. 1, let us next study an example of a medical communications system in which the embodiments of the invention can be applied. However, the embodiments are not limited to the systems described in these examples; on the contrary, a person skilled in the art is able to apply the inventive solution also to other systems.

The medical communication system of FIG. 1 comprises a terminal device 100 and several medical database storing systems 104, 106, 108, 110 communicating with the terminal device 100 over communications connections 112, 114, 116, 118. The communications connections 112, 114, 116, 118 between the terminal device 100 and the medical database storing systems 104, 106, 108, 110 can be wireless or cable connections known per se. The medical database storing systems 104, 106, 108, 110 may comprise separate computer devices or server computers in a communications network. It is possible that the medical database storing systems 104, 106, 108, 110 can establish connections with each other as well as with the terminal device 100. The medical database storing systems 104, 106, 108, 110 may be electronic medical record systems, a radiological picture archiving and communications systems, laboratory result archiving systems, magnetic resonance imaging systems, computer tomography systems or computerized radiogram systems, for example.

In an embodiment, the terminal device 100 is configured to retrieve medical content items 120, 122 stored in medical databases of the several medical database storing systems 104, 106, 108, 110. The medical content items 120, 122 are related to patients, and comprise at least one of: text, pictures, medical images, parts of electronic medical records, laboratory results, diagrams, audio, video, annotation data, or any combination thereof.

In an embodiment, the terminal device 100 is further configured to assemble the retrieved medical content items 120, 122 related to the predetermined patient on at least one medical workspace 102A, 102B, 102C. Then the terminal device 100 is configured to relate the medical content items 120, 122 on the medical workspace 102A to a particular moment in time, and to store the medical workspace 102A including the medical content items related to the particular moment in time for examining at a later time. The particular moment in time is related to a clinical decision-making point related to the patient on the basis of the medical content items assembled on the medical workspace 102A, for example.

The terminal device 100 may be a standalone or a server-client system, which when used with a computer at the point of service allows the user to create momentary workspaces. The workspaces 102A, 102B, 102C are montages of medical information obtained form the various medical databases, or created by data obtained from them, and placed on the same workspace 102A or workspaces 102A, 102B, 102C. Thus, the user assembles, by writing or by transferring from the medical database storing systems 104, 106, 108, 110, for example by using standard copy-paste techniques, a collection of medical information on the medical workspace 102A, which is then stored for future reference.

The medical content items can be in the form of text, graphs, analyses, pictures, reconstructed pictures, and so on. The medical content item may consist of all the information that is used at the moment in question to form an informed opinion leading to a clinical decision on the preferred management of the patient. This montage of information in the workspace 102A is then stored. The different workspaces 102A, 102B, 102C may comprise, for example, “snapshots” over a period of time of the patients medical history. The workspaces 102A, 102B, 102C may then include medical content items that were used to making decisions concerning the patient in question.

In an embodiment, when the patient's course is later examined, one needs only to review the various time-stamped workspaces 102A instead of having to access and reanalyze all of the enormous amounts of information amassed at each point of the management process.

FIG. 2 illustrates an example of a terminal device that can be used in a medical communication system. The terminal device of FIG. 2 comprises a processing unit 200 for controlling functions of the terminal device, a communications unit 202 for communicating with medical database storing systems, a memory 204, and a user interface 206. The communications unit 202 is configured to retrieve medical content items related to a predetermined patient stored in medical databases of the medical database storing systems.

In an embodiment, the processing unit 200 is configured to assemble the retrieved medical content items 120, 122 related to the predetermined patient on at least one medical workspace 102A, 102B. The processing unit 200 is further configured to relate the medical content items 120, 122 on the medical workspace 102A, 102B to a particular moment in time, and to store the medical workspace 102A, 102B including the medical content items 120, 122 related to the particular moment in time in the memory 204 for examining at a later time.

In an embodiment, the user interface 206 comprises a display, and the user interface 206 is configured to display the medical workspace 102A including the medical content items on the display. The user interface 206 may further comprise an input device for inserting one or more content items to the medical workspace 102A. The content items that may be input by using the input device may comprise text, hand-writing, an image or a drawing, for example. The user may wish to insert some comments, decisions or annotations to the workspace 102A, for example, and may thus use the input device for those purposes.

At an initial point in time, the user may access an electronic patient record and select a record of the patient in question. The information, i.e. the medical content items, in the various other medical databases is also perused and essential information can be noted. Then the medical workspace is selected in the terminal device. A blank workspace with appropriate configuration and commands may be shown on the user interface 206 of the terminal, for example. The information, i.e. the medical content items, leading to a decision at the particular moment of decision-making may be chosen to be displayed on the user interface 206. The information may be in form of separate notes, text from the EPR, images from the PACS, images from digital imaging and communication in medicine (DICOM) system, reconstructions of data and so on. It is also possible, that some content items assembled on the medical workspace are links to specific databases in the medical communications system or in the Internet, for example.

Various other input devices may be connected to the terminal device, for example, in order to manipulate imaging data to give new rendering of the information, which can be frozen and selected. At later time, the user can review the medical workspaces that have been created earlier to get overall views of the decision-making process.

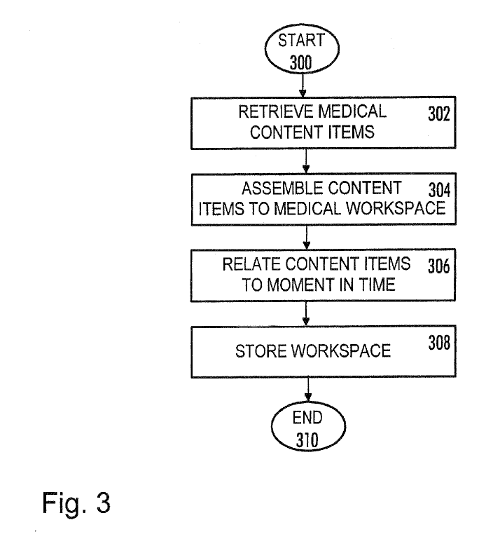

Finally, FIG. 3 illustrates a method of providing medical content in a medical communication system. The method starts in 300. In 302, medical content items stored in separate medical databases in the medical communications system are retrieved. In 304, the retrieved medical content items related to the predetermined patient are assembled on at least one medical workspace. In 306, the medical content items on the medical workspace are related to a particular moment in time, and in 308, the medical workspace including the medical content items related to the particular moment in time is stored for examining at a later time. The method ends in 310.

Even though the invention is described above with reference to an example according to the accompanying drawings, it is clear that the invention is not restricted thereto but it can be modified in several ways within the scope of the appended claims.

1. A method of providing medical content in a medical communication system, the method comprising retrieving (302) medical content items stored in separate medical databases in the medical communications system, the medical content items being related to a predetermined patient, characterized by the method further comprising:
assembling (304) the retrieved medical content items and any other information related to the predetermined patient on at least one medical workspace;
relating (306) the medical content items on the medical workspace to a particular moment in time; and
storing (308) the medical workspace including the medical content items related to the particular moment in time for examining at a later time.

2. The method of claim 1, characterized by the medical content items comprising at least one of: text, pictures, medical images, parts of electronic medical records, laboratory results, diagrams, audio, video, annotation data, or any combination thereof.

3. The method of claim 1, characterized by the method further comprising inserting one or more content items to the medical workspace by an input device, the content item comprising at least one of text, handwriting, an image, a drawing.

4. The method of claim 1, characterized in that the particular moment in time is related to a clinical decision-making point related to the patient on the basis of the medical content items assembled on the medical workspace.

5. The method of claim 1, characterized by the method further comprising storing the medical workspace in a database for medical workspaces, and retrieving a predetermined stored medical workspace for examining by selecting the predetermined medical workspace from the database.

6. A medical communication system, comprising: a terminal device (100) and several medical database storing systems (104, 106, 108, 110) communicating with the terminal device (100) over a communications connection, the terminal device (100) being configured to retrieve medical content items (120, 122) stored in medical databases of the several medical database storing systems (104, 106, 108, 110), the medical content items (120, 122) being related to a predetermined patient, characterized in that the terminal device (100) is further configured to assemble the retrieved medical content items and any other information related to the predetermined patient on at least one medical workspace (102A, 102B, 102C); to relate the medical content items on the at least one medical workspace (102A, 102B, 102C) to a particular moment in time; and to store the medical workspace (102A, 102B, 102C) including the medical content items related to the particular moment in time for examining at a later time.

7. The medical communication system of claim 6, characterized in that the medical database storing systems (104, 106, 108, 110) comprise at least one of: an electronic medical record system, a radiological picture archiving and communications systems, a laboratory result archiving system, a magnetic resonance imaging system, a computer tomography system, a computerized radiogram system.

8. The medical communication system of claim 6, characterized in that the medical content items (120, 122) comprising at least one of: text, pictures, medical images, parts of electronic medical records, laboratory results, diagrams, audio, video, annotation data, or any combination thereof.

9. The medical communication system of claim 6, characterized in that the terminal device (100) is further configured to store the medical workspace (102A, 102B, 102C) in a database (204) for medical workspaces, and retrieving a predetermined stored medical workspace (102A, 102B, 102C) for examining by selecting the predetermined medical workspace from the database (204).

10. A terminal device for a medical communication system, the terminal device comprising a processing unit (200) for controlling functions of the terminal device, a communications unit (202) for communicating with medical database storing systems, a memory (204), and a user interface (206), the communications unit (202) being configured to retrieve medical content items stored in medical databases of the medical database storing systems, the medical content items being related to a predetermined patient, characterized in that the processing unit (200) is configured to assemble the retrieved medical content items and any other information related to the predetermined patient on at least one medical workspace; to relate the medical content items on the at least one medical workspace to a particular moment in time; and to store the medical workspace including the medical content items related to the particular moment in time in the memory for examining at a later time.

11. The terminal device of claim 10, characterized in that the user interface (206) further comprises a display, and the user interface is configured to display the medical workspace including the medical content items on the display.

12. The terminal device of claim 10, characterized in that the medical content items comprising at least one of: text, pictures, medical images, parts of electronic medical records, laboratory results, diagrams, audio, video, annotation data, or any combination thereof.

13. The terminal device of claim 10, characterized in that the user interface (206) further comprises an input device for inserting one or more content items to the medical workspace, the content item comprising at least one of text, hand-writing, an image, a drawing.

14. A computer program product encoding a computer program of instructions for executing a computer process for providing medical content in a medical communication system, the process comprising: retrieving medical content items stored in separate medical databases in a communications system, the medical content items being related to a predetermined patient; assembling the retrieved medical content items and any other information related to the predetermined patient on at least one medical workspace; relating the medical content items on the at least one medical workspace to a particular moment in time; and storing the medical workspace including the medical content items related to the particular moment in time for examining at a later time.

15. A terminal device for a medical communication system, the terminal device comprising a processing unit for controlling functions of the terminal device, a communications unit for communicating with medical database storing systems, a memory, and a user interface, the communications unit retrieves medical content items stored in medical databases of the medical database storing systems, the medical content items being related to a predetermined patient, characterized by the processing unit further comprises: assembling means for assembling the retrieved medical content items and any other information related to the predetermined patient on at least one medical workspace; relating means for relating the medical content items on the at least one medical workspace to a particular moment in time; and storing means for storing the medical workspace including the medical content items related to the particular moment in time in the memory for examining at a later time.
